(19) United States
(12) Patent Application Publication
(10) Pub. No.: US 2023/0206168 A1
(43) Pub. Date: Jun. 29, 2023

(54) DELIVERY MANAGEMENT DEVICE AND DELIVERY MANAGEMENT METHOD

(71) Applicant: JVCKENWOOD Corporation, Yokohama-shi (JP)

(72) Inventors: Takumi Suzuki, Yokohama-shi (JP); Miki Oikawa, Yokohama-shi (JP); Sho Takashima, Yokohama-shi (JP); Yasushi Jinbo, Yokohama-shi (JP); Kenji Kano, Yokohama-shi (JP)

(21) Appl. No.: 18/076,439

(22) Filed: Dec. 7, 2022

(30) Foreign Application Priority Data
Dec. 23, 2021 (JP) 2021-209877

(51) Int. Cl. G06Q 10/0833; G06Q 50/30; H04W 4/021; H04W 4/02

(52) U.S. Cl. CPC G06Q 10/0833; G06Q 50/30; H04W 4/021; H04W 4/025

(57) ABSTRACT

A delivery management device that manages a package to be delivered to a delivery address includes a geofence setting unit that sets a geofence for each delivery address to which the package is delivered; a position information acquisition unit that acquires position information on a vehicle that delivers the package; a position information determination unit that determines whether a current position of the vehicle that delivers the package to the delivery address is positioned within the geofence corresponding to the delivery address; and a notification controller that transmits notification information to a terminal device in the delivery address of the package when it is determined that the current position of the vehicle is positioned within the geofence.

### CROSS-REFERENCE TO RELATED APPLICATION

This application claims the benefit of priority from Japanese Patent Application No. 2021-209877 filed on Dec. 23, 2021, the entire contents of which are incorporated herein by reference.

### BACKGROUND

### 1. Technical Field

The present disclosure relates to a delivery management device and a delivery management method.

### 2. Description of the Related Art

In services of delivering a package that is purchased by online shopping, or the like, a technique enabling tracking of the position of the package is known. For example, Japanese Laid-open Patent Publication No. 2005-112571 A discloses a technique enabling a recipient of a package to know that the package will be delivered when the van that conveys the package is positioned within a given area has been disclosed.

Even when the van conveying the package is positioned within the given area, the package is not necessarily delivered immediately. Furthermore, if the package is delivered when the recipient is cooking or in a bathroom, the recipient sometimes cannot receive the package. It is preferable that the recipient prepare for receiving the package while the package is in transit.

### SUMMARY

A delivery management device according to the present disclosure manages a package to be delivered to a delivery address. The delivery management device includes a geofence setting unit that sets a geofence for each delivery address to which the package is delivered, a position information acquisition unit that acquires position information on a vehicle that delivers the package, a position information determination unit that determines whether a current position of the vehicle that delivers the package to the delivery address is positioned within the geofence corresponding to the delivery address, and a notification controller that transmits notification information to a terminal device in the delivery address of the package when it is determined that the current position of the vehicle is positioned within the geofence.

A delivery management method according to the present disclosure includes setting a geofence for each delivery address to which the package is delivered; acquiring position information on a vehicle that delivers the package; determining whether a current position of the vehicle that delivers the package to the delivery address is positioned within the geofence corresponding to the delivery address, and transmitting notification information to a terminal device in the delivery address of the package when it is determined that the current position of the vehicle is positioned within the geofence.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating a configuration example of a delivery management system according to a first embodiment;

FIG. 2 is a block diagram illustrating a configuration example of a delivery management device according to the first embodiment;

FIG. 3 is a diagram illustrating an example of user information according to the first embodiment;

FIG. 4 is a diagram illustrating an example of package information according to the first embodiment;

FIG. 5 is a diagram illustrating an example of loading information according to the first embodiment;

FIG. 6 illustrates an example of geofence information according to the first embodiment;

FIG. 7 is a block diagram illustrating a configuration example of a terminal device according to the first embodiment;

FIG. 8 is a block diagram illustrating a configuration example of an on-board device according to the first embodiment;

FIG. 9 is a flowchart illustrating a process of setting a geofence according to the first embodiment;

FIG. 10 is a diagram for describing a method of setting a geofence according to the first embodiment;

FIG. 11 is a flowchart illustrating a process of transmitting notification information according to the first embodiment;

FIG. 12 is a diagram for describing a method of determining whether a vehicle turns off into a side road according to the first embodiment;

FIG. 13 is a flowchart illustrating a notifying process according to the first embodiment;

FIG. 14 is a diagram illustrating a configuration example of a delivery management system according to a modification of the first embodiment;

FIG. 15 is a block diagram illustrating a configuration example of a delivery management device according to the modification of the first embodiment;

FIG. 16 is a flowchart illustrating a process of transmitting notification information according to a second embodiment;

FIG. 17 is a diagram for describing a method of determining whether an entrance of a delivery address faces a main road according to the second embodiment;

FIG. 18 is a flowchart illustrating a notifying process according to the second embodiment;

FIG. 19 is a flowchart illustrating a process of setting a geofence according to a third embodiment;

FIG. 20 is a diagram for describing a method of detecting a main road around a delivery address according to the third embodiment;

FIG. 21 is a diagram for describing a method of setting a geofence according to the third embodiment;

FIG. 22 is a block diagram illustrating a configuration example of a delivery management device according to a fourth embodiment;

FIG. 23 is a diagram illustrating an example of loading information according to the fourth embodiment;

FIG. 24 is a flowchart illustrating a process of transmitting notification information according to the fourth embodiment;

FIG. 25 is a diagram illustrating a configuration example of a delivery management system according to a fifth embodiment;

FIG. 26 is a diagram for describing an overview of the fifth embodiment;

FIG. 27 is a block diagram illustrating a configuration example of a read device according to the fifth embodiment;

FIG. 28 is a block diagram illustrating a configuration example of a delivery management device according to the fifth embodiment;

FIG. 29 is a flowchart illustrating a process of transmitting notification information according to the fifth embodiment;

FIG. 30 is a diagram illustrating a configuration example of a delivery management system according to a sixth embodiment;

FIG. 31 is a diagram for describing an overview of the sixth embodiment;

FIG. 32 is a block diagram illustrating a configuration example of a deliverer terminal device according to the sixth embodiment;

FIG. 33 is a block diagram illustrating a configuration example of a delivery management device according to the sixth embodiment; and

FIG. 34 is a flowchart illustrating a process of transmitting notification information according to the sixth embodiment.

### DETAILED DESCRIPTION OF THE PREFERRED EMBODIMENTS

With reference to the accompanying drawings, embodiments according to the present disclosure will be described in detail below. Note that the embodiments do not limit the disclosure and, in the following embodiments, the same reference numerals are assigned to the same components and thus redundant description will be omitted.

### First Embodiment

Delivery Management System

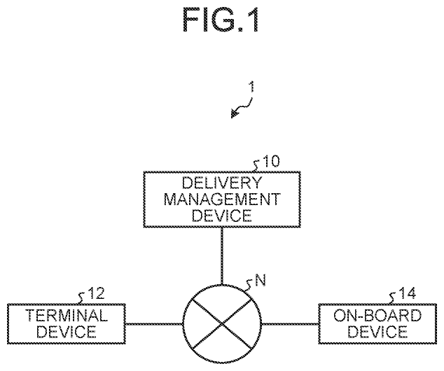

Using FIG. 1, a delivery management system according to a first embodiment will be described. FIG. 1 is a diagram illustrating a configuration example of a delivery management system according to a first embodiment.

As illustrated in FIG. 1, the delivery management system 1 includes a delivery management device 10, a terminal device 12, and an on-board device 14. The delivery management device 10, the terminal device 12, and the on-board device 14 are connected via a network N such that the devices can communicate with one another. The network N is, for example, the Internet but is not limited to this.

In the first embodiment, the delivery management device 10 is set in an operator of a delivery business operator, or the like, and manages packages to be delivered to delivery addresses. The terminal device 12 is set in a delivery address of a package, such as home of a user of the delivery address. The on-board device 14 is set in a vehicle that is used to deliver the package. In the first embodiment, the vehicle includes various vehicles, such as a four-wheel vehicle, a two-wheel vehicle, and a wagon.

The delivery management device 10 acquires a current position of the vehicle from the on-board device 14 and determines whether the vehicle is positioned in a geofence that is set previously with respect to each delivery address. In the first embodiment, the geofence refers to an area on a map according to which the user is notified that the package is about to be delivered. When the delivery management device 10 determines that the vehicle that is conveying the package of the user is positioned in a geofence corresponding to the user, the terminal device 12 notifies the user of information on the package, for example, that the package is about to be delivered.

The delivery management system 1 according to the first embodiment, for example, notifies a user that a package that is purchased by online shopping, or the like, is about to be delivered. The delivery management system 1 may be, for example, a system that notifies a user that food or drink is about to be delivered in food and drink delivery services.

Delivery Management Device

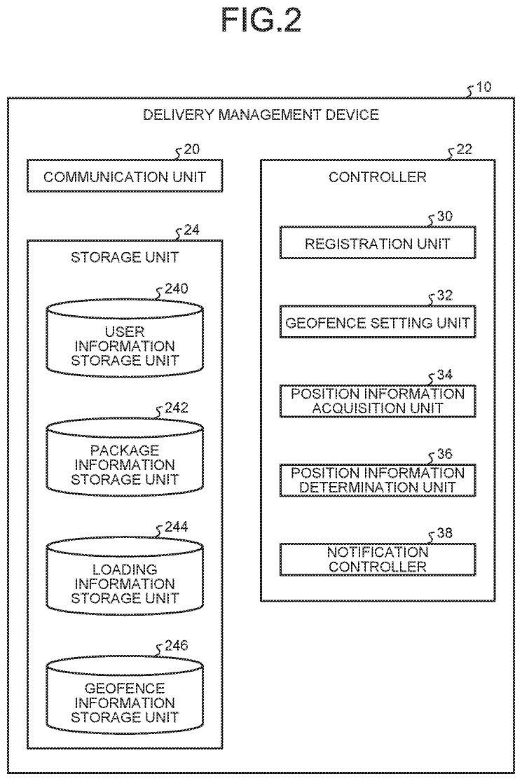

Using FIG. 2, a configuration example of the delivery management device according to the first embodiment will be described. FIG. 2 is a block diagram illustrating a configuration example of a delivery management device according to the first embodiment.

As illustrated in FIG. 2, the delivery management device 10 includes a communication unit 20, a controller 22, and a storage unit 24. The delivery management device 10 consists of, for example, a general-purpose server device, or the like.

The communication device 20 executes communication between the delivery management device 10 and the external device. The communication unit 20 executes, for example, communication between the delivery management device 10 and the terminal device 12. The communication unit 20, for example, executes communication between the delivery management device 10 and the on-board device 14.

The controller 22 controls each unit of the delivery management device 10. The controller 22 includes, for example, an information processing device, such as a central processing unit (CPU) or a micro processing unit (MPU), and a storage device, such as a random access memory (RAM) or a read only memory (ROM). The controller 22 executes a program for controlling operations of the delivery management device 10 according to the disclosure. The controller 22, for example, may be realized using an integrated circuit, such as an application specific integrated circuit (ASIC) or a field programmable gate array (FPGA). The controller 22 may be realized by a combination of hardware and software.

The controller 22 includes a registration unit 30, a geofence setting unit 32, a position information acquisition unit 34, a position information determination unit 36, and a notification controller 38.

The registration unit 30 registers user information. The registration unit 30 registers, as the user information, information on the user of the delivery address of the package and information on the driver who delivers the package by vehicle in association with each other. The user information includes identification, a name, and information on a notification destination for transmitting information. The registration unit 30 causes a user information storage unit 240 of the storage unit 24 to store the user information. Details of the user information will be described below.

The registration unit 30 registers identification of the vehicle that delivers the package. The registration unit 30, for example, associates the identification of the vehicle with the user information that is stored in the user information storage unit 240.

The registration unit 30 registers package information in which identification of the package to be delivered and identification of the user of the delivery address are associated with each other. The registration unit 30 stores the package information in a package information storage unit 242 of the storage unit 24. Details of the package information will be described below.

The registration unit 30 registers loading information in which the identification of the vehicle that delivers the package, the identification of the package to be delivered, and the identification of the user of the delivery address are associated with one another. The registration unit 30 stores the package information in a loading information storage unit 244 of the storage unit 24. Details of the loading information will be described below.

The geofence setting unit 32 sets a geofence for each delivery address. The geofence setting unit 32 sets a geofence based on the address of the user of the delivery address. The geofence setting unit 32 stores, in a geofence information storage unit 246, geofence information in which the geofence that is set for each delivery address is associated with the identification of the user. Details of the geofence information will be described below.

The position information acquisition unit 34 acquires position information on the vehicle that is delivering the package. The position information acquisition unit 34, for example, acquires the position information from the on-board device 14 that is installed in the vehicle via the communication unit 20.

The position information determination unit 36 determines whether the vehicle that is delivering the package is positioned in the geofence. The position information determination unit 36 determines whether the vehicle that is delivering the package is positioned in the geofence based on the position information on the vehicle that is acquired by the position information acquisition unit 34 and the geofence information that is stored in the geofence information storage unit 246.

The notification controller 38 generates notification information indicating that the package is about to be delivered. When it is determined that the vehicle that is delivering the package is positioned in the geofence, the notification controller 38 transmits the notification information via the communication unit 20 to the terminal device 12 of the user of the delivery address of the package.

The storage unit 24 stores various types of information. The storage unit 24 stores information, such as the content of arithmetic operations performed by the controller 22 and programs. The storage unit 24, for example, includes at least one of a random access memory (RAM), a main storage device, such as a read only memory (ROM), and an external storage device, such as a hard disk drive (HDD).

The storage unit 24 stores the user information storage unit 240, the package information storage unit 242, the loading information storage unit 244, and the geofence information storage unit 246.

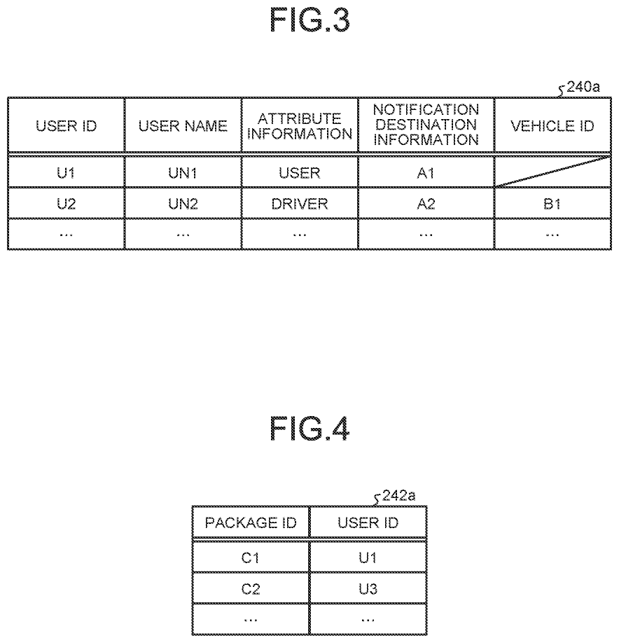

The user information storage unit 240 stores the user information. FIG. 3 is a diagram illustrating an example of the user information according to the first embodiment.

As illustrated in FIG. 3, user information 240a contains items of “user ID”, “user name”, “attribute information”, “notification destination information”, and “vehicle ID”. The user information 240a is information in which a “user ID”, a “user name”, “attribute information”, “notification destination information”, and a “vehicle ID” are associated with one another. In the user information 240a, address information on the user may be associated.

The user ID is an identifier for uniquely identifying the user. In the example illustrated in FIG. 3, the user ID is schematically represented by, “U1”, or the like; however, practically, the user ID may be represented by a specific number, or the like.

The user name represents the name of the user. In the example illustrated in FIG. 3, the user name is represented by “UN1”, or the like; however, practically, a specific name is presented.

The attribute information represents an attribute of the user. In the first embodiment, the attribute presents whether the user is the “user” of the delivery address of the package or the “driver” who is delivering the package.

The notification information represents information on the notification destination that is notified of the notification information indicating that the package is to be delivered. In the example illustrated in FIG. 3, the notification information is schematically represented by, “A1”, or the like; however, practically, address information, a phone number, etc., of a smart speaker, a smart interphone, a smartphone, or the like, that is the notification destination of the notification information are presented.

The vehicle ID is an identifier for uniquely identifying the vehicle that delivers the package. The vehicle ID is associated with only the user whose attribute is “driver”. In the example illustrated in FIG. 3, the vehicle ID is schematically represented by, “B1”, or the like; however, practically, the driver ID may be represented by a vehicle number of the vehicle that delivers the package, or the like.

For example, FIG. 3 presents that the user whose user ID is “U1” corresponds to a user name of “UN1”, attribute information of “user”, and notification destination information of “A1”.

The package information storage unit 242 stores the package information. FIG. 4 is a diagram illustrating an example of the package information according to the first embodiment.

As illustrated in FIG. 4, package information 242a contains items of “package ID” and “user ID”. The package information 242a is information in which a “package ID” and a “user ID” are associated with each other. In the package information 242a, address information on the delivery address of the package may be associated.

The package ID is an identifier for uniquely identifying the package. In the example illustrated in FIG. 4, the package ID is schematically represented by, “C1”, or the like; however, practically, a delivery number, or the like, is presented.

For example, FIG. 4 presents that the package whose package ID is “C1” is a package that is to be delivered to the user whose user ID is “U1”.

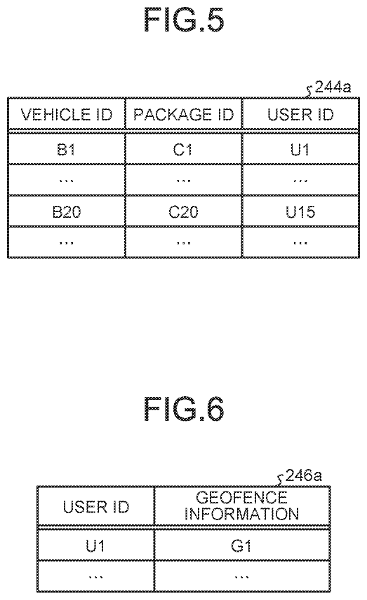

The loading information storage unit 244 stores the loading information. FIG. 5 is a diagram illustrating an example of the loading information according to the first embodiment.

As illustrated in FIG. 5, loading information 244a contains items of “vehicle ID”, “package ID”, and “user ID”. The loading information 244a is information in which a “vehicle ID”, a “package ID”, and a “user ID” are associated with one another.

For example, FIG. 5 presents that the vehicle whose vehicle ID is “B1” delivers the package whose package ID is “C1” to the user whose user ID is “U1”.

The geofence information storage unit 246 stores the geofence information. FIG. 6 illustrates an example of geofence information according to the first embodiment.

As illustrated in FIG. 6, geofence information 246a contains items of “user ID” and “geofence information”. The geofence information 246a is information in which a “user ID” and “geofence information” are associated with each other.

The geofence information contains information on an area of the geofence. In the example illustrated in FIG. 6, the geofence information is schematically represented by, “G1”, or the like; however, practically, the area is represented using a latitude and a longitude, or the like. In the geofence information, the area may be represented by a specific address.

Terminal Device

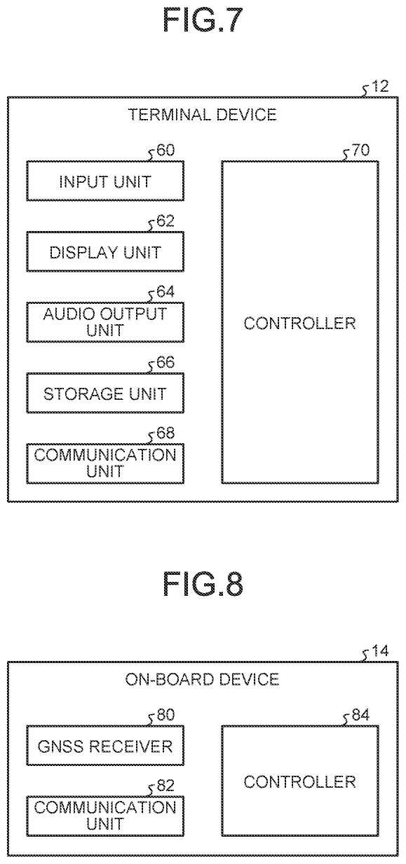

Using FIG. 7, a configuration example of the terminal device according to the first embodiment will be described. FIG. 7 is a block diagram illustrating a configuration example of the terminal device according to the first embodiment.

As illustrated in FIG. 7, the terminal device 12 includes an input unit 60, a display unit 62, an audio output unit 64, a storage unit 66, a communication unit 68, and a controller 70. The terminal device 12 is, for example, an information terminal device, such as a smart speaker, a smart interphone, a smartwatch, a smartphone, a tablet terminal device, or a mobile phone.

The input unit 60 receives various input operations on the terminal device 12. The input unit 60 outputs an input signal corresponding to a received input operation to the controller 70. The input unit 60, for example, includes a touch panel, a button, a switch, or a microphone. When a touch panel is used as the input unit 60, the input unit 60 is arranged on the display unit 62.

The display unit 62 displays various videos. The display unit 62, for example, displays a video of the notification information indicating that the package is to be delivered. The display unit 62 is a type of notifier. The display unit 62 is a display containing a liquid crystal display (LCD) or an organic electro-luminescence (EL). For example, when the terminal device 12 is a smart speaker, or the like, the terminal device 12 need not include the display unit 62.

The audio output unit 64 is a speaker that outputs sound. The audio output unit 64, for example, outputs the notification information indicating that the package is to be delivered by sound. The audio output unit 64 is a type of notifier.

The storage unit 66, for example, stores information, such as the content of arithmetic operations performed by the controller 70 and programs. The storage unit 66, for example, includes at least one of a RAM, a main storage device, such as a ROM, and an external storage device, such as a HDD.

The communication unit 68 executes communications between the terminal device 12 and the external device. The communication unit 68, for example, executes communications between the terminal device 12 and the delivery management device 10.

The controller 70 controls each unit of the terminal device 12. The controller 70, for example, includes an information processing device, such as a CPU or a MPU, and a storage device, such as a RAM or a ROM. The controller 70 executes a program for controlling operations of the terminal device 12 according to the disclosure. The controller 70, for example, may be realized using an integrated circuit, such as a ASIC or a FPGA. The controller 70 may be realized by a combination of hardware and software.

On-Board Device

Using FIG. 8, a configuration example of the on-board device according to the first embodiment will be described. FIG. 8 is a block diagram illustrating a configuration example of the on-board device according to the first embodiment.

As illustrated in FIG. 8, the on-board device 14 includes a GNSS (Global Navigation Satellite System) receiver 80, a communication unit 82, and a controller 84. The on-board device 14 is installed in the vehicle that delivers the package.

The GNSS receiver 80 receives a GNSS signal containing information for specifying the position information from a GNSS satellite (not illustrated in FIG. 8). The GNSS receiver 80, for example, can be realized using a GNSS receiving circuit or a GNSS receiving device. The GNSS receiver 80 may receive information for specifying the position information from one other than the GNSS satellite.

The communication unit 82 executes communication between the on-board device 14 and the external device. The communication unit 82, for example, executes communication between the on-board device 14 and the delivery management device 10.

The controller 84 controls each unit of the on-board device 14. The controller 84, for example, includes an information processing device, such as a CPU or a MPU, and a storage device, such as a RAM or a ROM. The controller 84 executes a program for controlling operations of the on-board device 14 according to the disclosure. The controller 84, for example, may be realized using an integrated circuit, such as a ASIC or a FPGA. The controller 84 may be realized by a combination of hardware and software.

The controller 84 calculates a current position of the vehicle based on the GNSS signal that is received by the GNSS receiver 80. Based on the GNSS signal, the controller 84 calculates position information on the vehicle in which the on-board device 14 is installed. The controller 84, for example, calculates position information on the vehicle in which the on-board device 14 is installed using geographic coordinates. The controller 84 transmits the calculated position information to the delivery management device 10 via the communication unit 82.

The controller 84, for example, may acquire various types of vehicle information via a controller area network (CAN), or the like. The vehicle information, for example, can contain speed information, steering wheel operation information, acceleration operation information, braking information, and blinker operation information; however, the vehicle information is not limited to them.

Geofence Setting Process

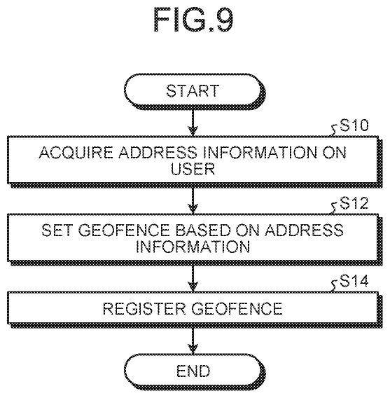

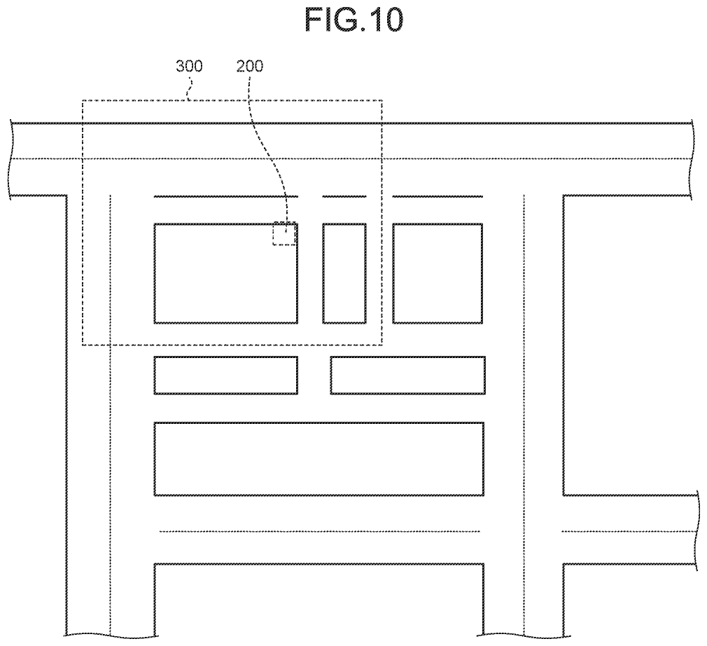

Using FIG. 9, a process of setting a geofence according to the first embodiment will be described. FIG. 9 is a flowchart illustrating the process of setting a geofence according to the first embodiment.

FIG. 9 illustrates a process in which the delivery management device 10 sets a geofence for each delivery address before delivery of packages to users.

The geofence setting unit 32 acquires the address information on the user of the delivery address (step S10). For example, based on the user information 240a that is stored in the user information storage unit 240 and the package information 242a that is stored in the package information storage unit 242, the geofence setting unit 32 acquires address information on the user of the delivery address of the packages. The process then proceeds to step S12.

Based on the address information, the geofence setting unit 32 sets a geofence (step S12). Specifically, based on the address information that is acquired at step S10, the geofence setting unit 32 sets a geofence. FIG. 10 is a diagram for describing a method of setting a geofence according to the first embodiment. FIG. 10 illustrates map information. FIG. 10 illustrates information of a map around a delivery address 200. In FIG. 10, the geofence setting unit 32 sets a geofence of the delivery address 200. In this case, for example, based on the address information on the delivery address 200, the geofence setting unit 32 sets a given area according to the town name, the street, the block number, etc., as a geofence 300. For example, using the input unit 60 of the terminal device 12, the user may manually adjust the geofence 300. The user may manually set the geofence 300, using the input unit 60 of the terminal device 12. The process then proceeds to step S14.

The geofence setting unit 32 registers the geofence (step S14). Specifically, the geofence setting unit 32 stores the geofence information 246a in which the user ID of the user and the geofence are associated with each other in the geofence information storage unit 246. The geofence setting unit 32 then ends the process in FIG. 9.

Notification Information Transmitting Process

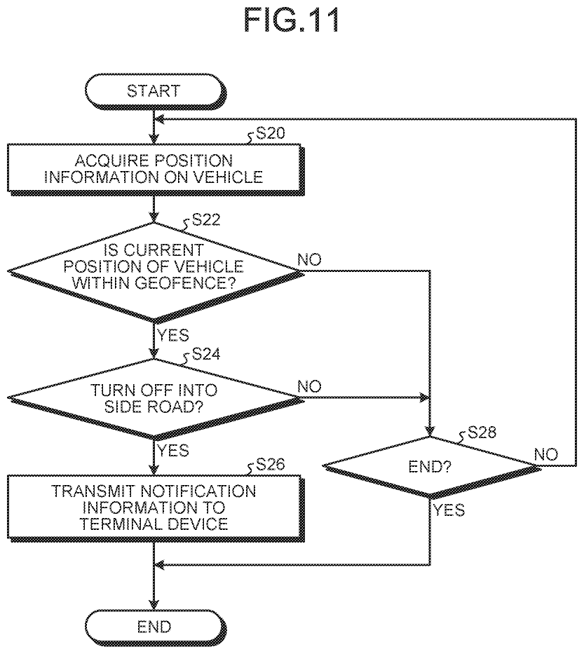

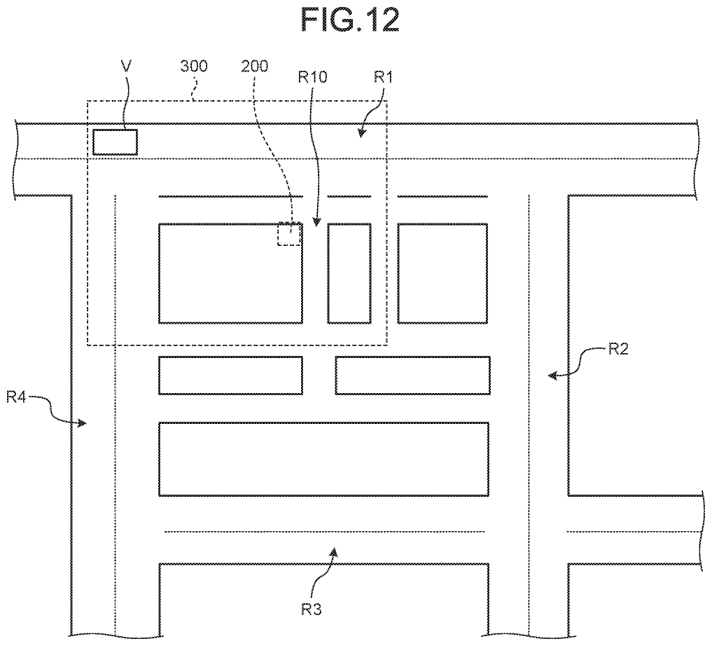

Using FIG. 11, a process of transmitting notification information according to the first embodiment will be described. FIG. 11 is a flowchart illustrating the process of transmitting notification information according to the first embodiment.

The position information acquisition unit 34 acquires the position information on the vehicle with the package being thereon (step S20). Specifically, based on the user information 240a that is stored in the user information storage unit 240 and the loading information 244a that is stored in the loading information storage unit 244, the position information acquisition unit 34 specifies the vehicle in which the package to be delivered to the user of subject is loaded. The position information acquisition unit 34 acquires the position information on the specified vehicle via the network N from the on-board device 14 that is installed in the vehicle. The process then proceeds to step S22.

The position information determination unit 36 determines whether a current position of the vehicle with the package being thereon is inside the geofence (step S22). Specifically, the position information determination unit 36 refers to the loading information 244a that is stored in the loading information storage unit 244 and specifies the user of the delivery address of the package that is on the vehicle. Based on the geofence information 246a that is stored in the geofence information storage unit 246, the position information determination unit 36 determines whether the current position of the vehicle is within the geofence of the user of the delivery address. When it is determined that the current position of the vehicle is within the geofence (YES at step S22), the process proceeds to step S24. When it is not determined that the current position of the vehicle is within the geofence (NO at step S22), the process proceeds to step S28.

When an YES determination is made at step S22, the position information determination unit 36 determines whether the vehicle traveling with the package thereon has turned off into a side road (step S24). FIG. 12 is a diagram for describing a method of determining whether the vehicle has turned off into a side road according to the first embodiment. In FIG. 12, a road R1, a road R2, a road R3, and a road R4 are main roads. In the first embodiment, a main road refers to any one of a highway, a road with multiple lanes, and a road on which the vehicle can enter another town or another street when traveling along the road. The definition of a main road may be changed depending on the area. For example, in a local area with a few roads, a road other than those under the conditions described above can be a main road. A road R10 is a side road. In the first embodiment, a side road refers to a road not corresponding to a main road. In FIG. 12, the geofence 300 is set for the delivery address 200. In FIG. 12, a vehicle V is traveling on the road R1. In this case, when the vehicle V has turned right on the road R1 and has entered the road R10, the position information determination unit 36 determines that the vehicle V has turned off into a side road based on the position information on the vehicle V that is acquired by the position information acquisition unit 34. The position information determination unit 36, for example, may determine that that the vehicle V has turned off into a side road based on information on a blinker operation for the vehicle V to enter the road R10 when traveling on the road R1 that is acquired from the on-board device 14. When it is determined that the vehicle has turned off into a side road (YES at step S24), the process proceeds to step S26. When it is not determined that the vehicle has turned off into a side road (NO at step S24), the process proceeds to step S28.

When a YES determination is made at step S24, the notification controller 38 transmits the notification information to the terminal device 12 via the communication unit 20 (step S26). Specifically, the notification controller 38 transmits the notification information for causing the terminal device 12 to output information indicating that the package is to be delivered to the terminal device 12 and ends the process in FIG. 11.

The controller 22 determines whether the process has ended (step S28). Specifically, when delivery of the package to the user of subject has ended, the controller 22 determines to end the process with respect to the user. When it is determined to end the process (YES at step S28), the process in FIG. 1 is ended. When it is not determined to end the process (NO at step S28), the process proceeds to step S20.

Notifying Process

Using FIG. 13, a notifying process according to the first embodiment will be described. FIG. 13 is a flowchart illustrating the notifying process according to the first embodiment.

The process illustrated in FIG. 13 is a process of the terminal device 12 performed to output sound saying that the package is to be delivered.

The controller 70 determines whether the notification information has been received (step S30). Specifically, the controller 70 determines whether the notification information has been received from the delivery management device 10. When it is determined that the notification information has been received (YES at step S30), the process proceeds to step S32. When it is not determined that the notification information has been received (NO at step S30), the process at step S30 is repeated.

When an YES determination is made at step S30, the controller 70 outputs the notification information (step S32). Specifically, the controller 70 causes the audio output unit 64 to output sound saying “The package is about to be delivered. Be ready for the delivery.”, or the like. The controller 70 may cause the display unit 62 to display text information saying “The package is about to be delivered. Be ready for the delivery.”, or the like. In the first embodiment, for example, the notification information is output few minutes or few seconds before the package is delivered actually. The process in FIG. 13 then ends.

As described above, in the first embodiment, when the vehicle that delivers the package enters the predetermined geofence and the vehicle enters a side road, the user is notified of the notification information. This enables the user to know that the package is about to be delivered about a few minutes before the delivery and thus ensure time for being ready to receive the package.

### Modification of First Embodiment

Delivery Management System

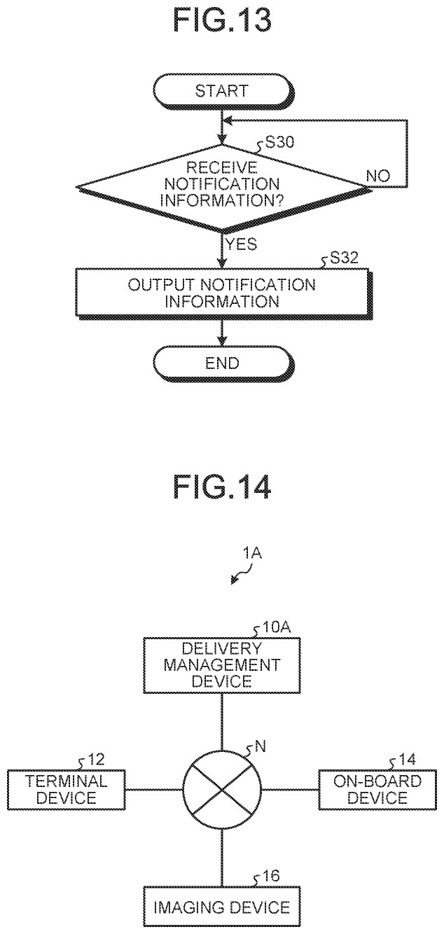

Using FIG. 14, a configuration example of a delivery management system according to a modification of the first embodiment will be described. FIG. 14 is a diagram illustrating the configuration example of the delivery management system according to the modification of the first embodiment.

As illustrated in FIG. 14, a delivery management system 1A is different from the delivery management system 1 illustrated in FIG. 1 in including an imaging device 16. In the modification of the first embodiment, it is determined whether a vehicle has entered a geofence based on data of an image of the vehicle that is captured by the imaging device 16.

The imaging device 16 is set in a position where the imaging device 16 can capture an image of the inside of the geofence. A plurality of the imaging devices 16 may be arranged in positions where the imaging devices 16 can capture images of the inside of the geofence. The imaging device 16 is, for example, a monitoring camera that is set at the entrance of a house or an apartment or a downtown monitoring camera. The imaging device 16, for example, captures an image of a license plate of the vehicle having entered the geofence.

Delivering Management Device

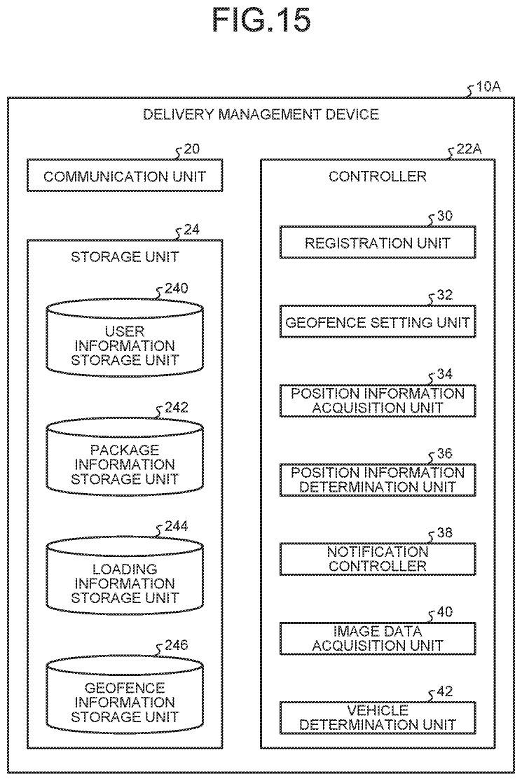

Using FIG. 15, a configuration example of a delivery management device according to the modification of the first embodiment will be described. FIG. 15 is a block diagram illustrating the configuration example of the delivery management device according to the modification of the first embodiment.

As illustrated in FIG. 15, a delivery management device 10A is different from the delivery management device 10 illustrated in FIG. 2 in that a controller 22A includes an image data acquisition unit 40 and a vehicle determination unit 42.

The image data acquisition unit 40 acquires various types of image data. The image data acquisition unit 40 acquires the image data from the imaging device 16. The image data acquisition unit 40 acquires the data of the image of the vehicle having entered the geofence from the imaging device 16.

The vehicle determination unit 42 determines whether the vehicle contained in the image data that is acquired by the image data acquisition unit 40 is the vehicle that is delivering the package. Based on the license plate of the vehicle contained in the image data that is acquired by the image data acquisition unit 40, the vehicle determination unit 42 determines whether the vehicle is the vehicle that is delivering the package. The vehicle determination unit 42, for example, executes an image recognizing process on the image data based on dictionary data (not illustrated in the drawing) and specifies the number on the license plate. The vehicle determination unit 42 refers to the loading information 244a that is stored in the loading information storage unit 244 and specifies the user of the delivery address of the package with which the license plate represented by a vehicle ID is associated. Based on the geofence information 246a that is stored in the geofence information storage unit 246, the vehicle determination unit 42 determines whether the current position of the vehicle is within the geofence of the user of the delivery address. Thus, in the modification of the first embodiment, it is possible to determine whether the vehicle that delivers the package has entered the predetermined geofence based on the image data.

### Second Embodiment

Notification Information transmitting Process

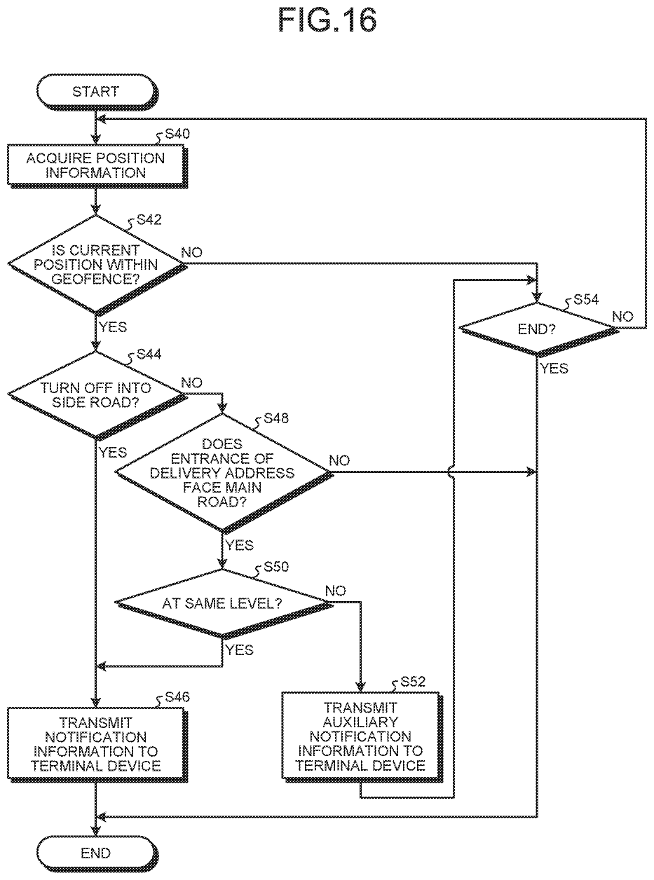

Using FIG. 16, a process of transmitting notification information according to a second embodiment will be described. FIG. 16 is a flowchart illustrating the process of transmitting notification information according to the second embodiment. A delivery management system according to the second embodiment is the same as the delivery management system 1 illustrated in FIG. 1 and thus description thereof will be omitted.

The sets of processing from step S40 to step S46 are the same as those of processing from step S20 to step S26 illustrated in FIG. 11, respectively, and thus description thereof will be omitted.

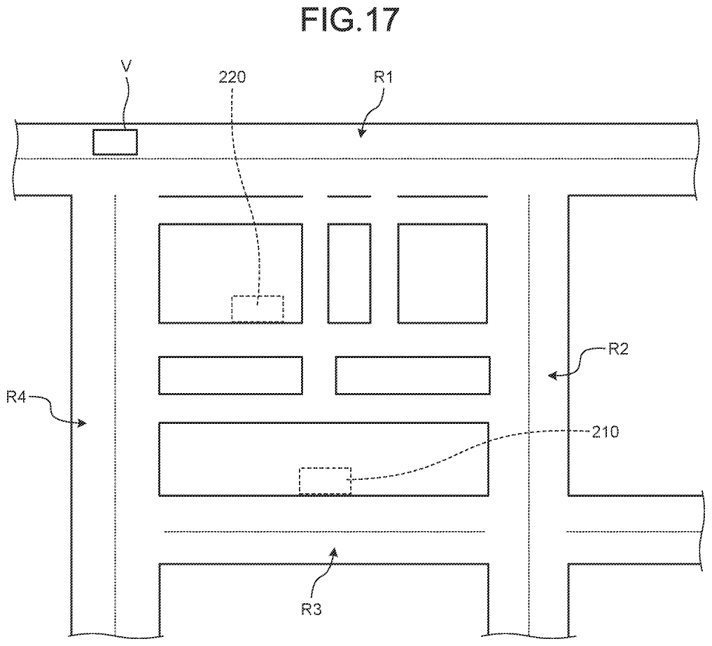

When a NO determination is made at step S44, the position information determination unit 36 determines whether the entrance of the delivery address faces a main road (step S48). FIG. 17 is a diagram for describing a method of determining whether an entrance of a delivery address faces a main road according to the second embodiment. As illustrated in FIG. 17, for example, because a delivery address 210 faces a road R3, the position information determination unit 36 determines that the entrance of the delivery address 210 faces a main road. For example, because a delivery address 220 faces none of the road R1, the road R2, the road R3, and the road R4, the position information determination unit 36 determines that the entrance of the delivery address 220 does not face a main road. When it is determined that the entrance of the delivery address faces a main road (YES at step S48), the process proceeds to step S50. When it is not determined that the entrance of the delivery address faces a main road (NO at step S48), the process proceeds to step S54.

When a YES determination is made at step S48, the position information determination unit 36 determines whether the entrance of the delivery address and the main road on which the vehicle is positioned currently are at the same level (step S50). Specifically, in the example illustrated in FIG. 17, when the road R3 is a highway, an elevated bridge, or the like, it is determined that the road R3 and the entrance of a delivery address 110 are at different levels. The same level includes not only the case where the levels match completely and the case where the levels match within a given range. When it is determined that the entrance of the delivery address and the main road are at the same level (YES at step S50), the process proceeds to step S46. When it is not determined that the entrance of the delivery address and the main road are at the same level (NO at step S50), the process proceeds to step S52.

When a NO determination is made at step S50, the notification controller 38 transmits auxiliary notification information to the terminal device 12 via the communication unit 20 (step S52). Specifically, the notification controller 38 transmits notification information for causing the terminal device 12 to output auxiliary information on delivery of the package to the terminal device 12, and the process proceeds to step S54. For example, when the entrance of the delivery address and the main road are at different levels, the auxiliary information can be information for causing recognition of existence of the vehicle because the vehicle that conveys the package would pass the entrance. Note that the position information determination unit 36 need not execute the process at step S50 and, in that case, when it is determined that the entrance of the delivery address faces a main road (YES at step S48), the process proceeds to step S52. The auxiliary information in this case can be information for causing recognition of existence of the vehicle because the vehicle that conveys the package would pass the entrance when the entrance of the delivery address faces a main road. Details of the notifying process based on the auxiliary notification information will be described below.

The process at step S54 is the same as the process at step S28 illustrated in FIG. 11 and thus description thereof will be omitted.

Notifying Process

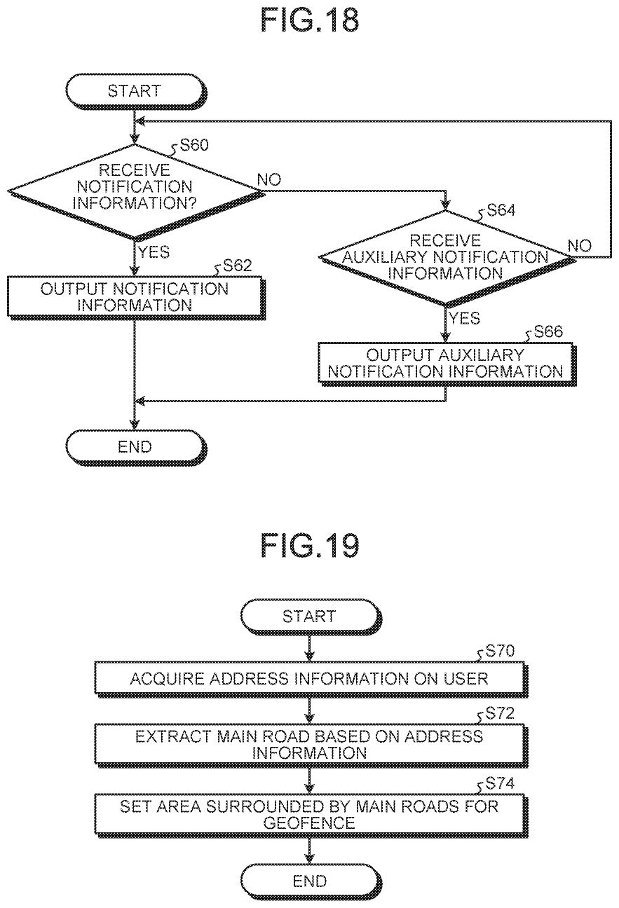

Using FIG. 18, the notifying process according to the second embodiment will be described. FIG. 18 is a flowchart illustrating the notifying process according to the second embodiment.

The sets of processing of steps S60 and S62 are the same as those at steps S30 and S32 illustrated in FIG. 13, respectively, and thus description thereof will be omitted.

When a NO determination is made at step S60, the controller 70 determines whether the auxiliary notification information is received (step S64). Specifically, the controller 70 determines whether the auxiliary notification information is received from the delivery management device 10. When it is determined that that auxiliary notification information is received (YES at step S64), the process proceeds to step S66. When it is not determined that auxiliary notification information is received (NO at step S64), the process proceeds to step S60.

When an YES determination is made at step S64, the controller 70 outputs the auxiliary notification information (step S66). Specifically, the controller 70 causes the audio output unit 64 to output sound saying “The delivery van is travelling close.”, or the like. The controller 70 may cause the display unit 62 to display text information saying “The delivery van is travelling close.”, or the like. The process in FIG. 18 then ends.

As described above, in the second embodiment, the vehicle that delivers the package enters the predetermined geofence and, according to the position of the entrance of the delivery address, that is, according to whether the entrance of the delivery address faces a main road or not, the content of the notification information is changed. Accordingly, in the second embodiment, it is possible to make a notification of more accurate notification information.

### Third Embodiment

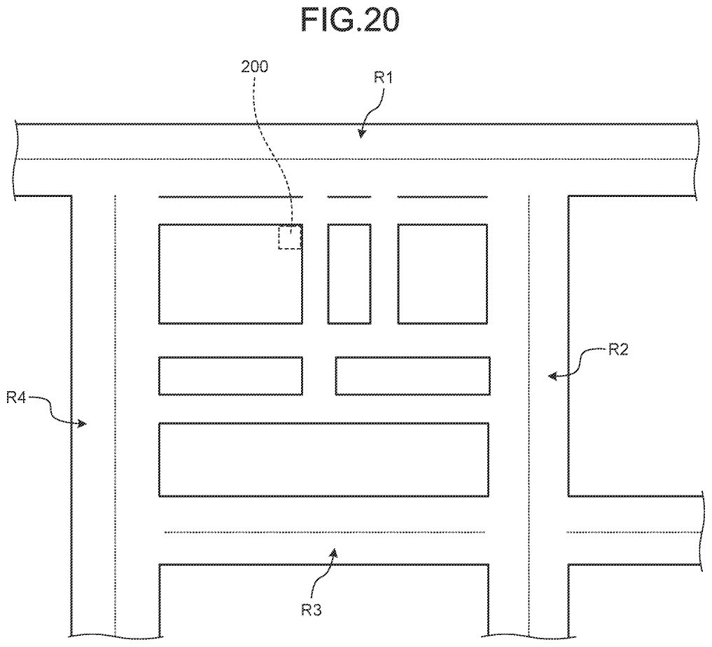

Using FIG. 19, a process of setting a geofence according to a third embodiment will be described. FIG. 19 is a flowchart illustrating the process of setting a geofence according to the third embodiment. A configuration of a delivery management device according to the third embodiment is the same as the configuration of the delivery management device 10 illustrated in FIG. 2 and thus description thereof will be omitted.

FIG. 19 illustrates a process in which the delivery management device 10 sets a geofence for each delivery address before delivery of packages to users.

The process at step S70 is the same as the process at step S10 illustrated in FIG. 9 and thus description thereof will be omitted.

Based on address information on a user, the geofence setting unit 32 detects a main road around a delivery address (step S72). FIG. 20 is a diagram for describing a method of detecting a main road around a delivery address according to the third embodiment. In the example illustrated in FIG. 20, the geofence setting unit 32 extracts the road R1, the road R2, the road R3, and the road R4 as main roads around the delivery address 200. The process then proceeds to step S74.

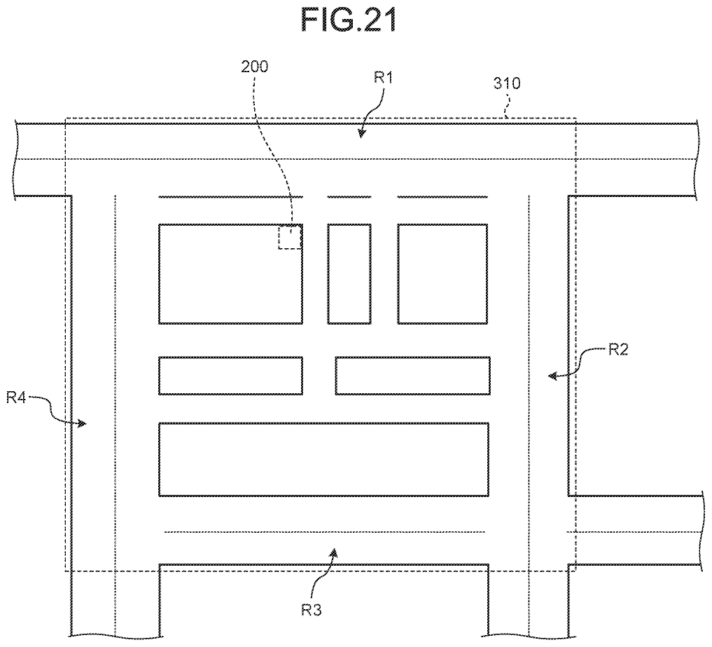

The geofence setting unit 32 sets, for a geofence, an area surrounded by the detected main roads (step S74). FIG. 21 is a diagram for describing a method of setting a geofence according to the third embodiment. As illustrated in FIG. 21, the geofence setting unit 32 sets, for a geofence 310, an area surrounded by the road R1, the road R2, the road R3, and the road R4. The process in FIG. 19 then ends.

A process of transmitting notification information according to the third embodiment is the same as the process illustrated in FIG. 11 or FIG. 16 and thus description thereof will be omitted.

### Fourth Embodiment

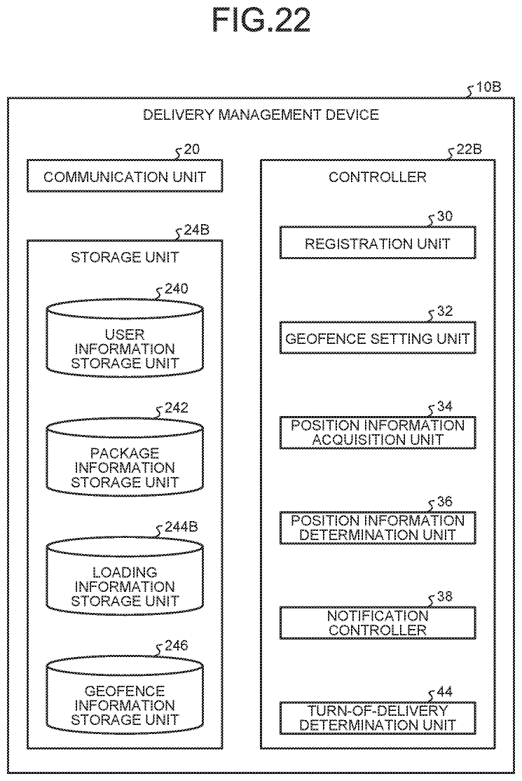

Using FIG. 22, a configuration example of a delivery management device according to a fourth embodiment will be described. FIG. 22 is a block diagram illustrating the configuration example of the delivery management device according to the fourth embodiment. A configuration of a delivery management system according to the fourth embodiment is the same as the delivery management system 1 illustrated in FIG. 1 and thus description thereof will be omitted.

As illustrated in FIG. 22, a delivery management device 10B is different from the delivery management device 10 illustrated in FIG. 2 in that a controller 22B includes a turn-of-delivery determination unit 44. The delivery management device 10B determines a turn of delivery of a package of a delivery address and, based on the turn of delivery, determines whether to transmit notification information.

In the fourth embodiment, a loading information storage unit 244B of a storage unit 24B stores loading information in which turns of delivery are associated.

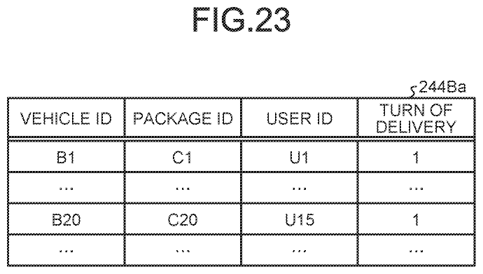

FIG. 23 is a diagram illustrating an example of the loading information according to the fourth embodiment. As illustrated in FIG. 23, loading information 244Ba contains items of “vehicle ID”, “package ID”, “user ID”, and “turn of delivery”. The loading information 244Ba is information in which a “vehicle ID”, a “package ID”, a “user ID”, and a “turn of delivery” are associated with one another.

A “turn of delivery” is set previously with respect to each “vehicle ID”. In the example illustrated in FIG. 23, the turn of delivery of a package whose corresponding “vehicle ID” is “B1” and whose “package ID” is “C1” is “1” and the turn of delivery of a package whose corresponding “vehicle ID” is “B20” and whose “package ID” is “C20” is “1”. In the fourth embodiment, it is determined whether to transmit the notification information according to the turns of delivery that are set previously.

The turn-of-delivery determination unit 44 determines a turn of a delivery address of a package. Based on the loading information 244Ba that is stored in the loading information storage unit 244B, the turn-of-delivery determination unit 44 determines the delivery address of the package.

Notification Information Transmitting Process

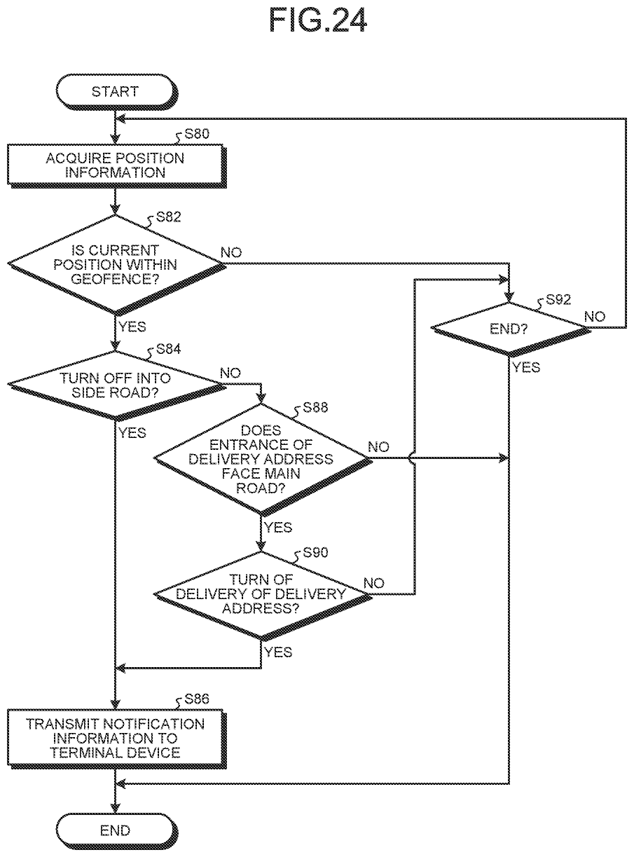

Using FIG. 24, a process of transmitting notification information according to the fourth embodiment will be described. FIG. 24 is a flowchart illustrating the process of transmitting notification information according to the fourth embodiment.

The sets of processing from step S80 to step S88 are the same as those from step S40 to step S48 illustrated in FIG. 16, respectively, and thus description thereof will be omitted.

When an YES determination is made at step S88, the turn-of-delivery determination unit 44 determines whether the turn of delivery of the delivery address comes (step S90). Specifically, based on the loading information 244Ba that is stored in the loading information storage unit 244B, the turn-of-delivery determination unit 44 determines the delivery address of the package. When it is determined that the turn of delivery of the delivery address comes (YES at step S90), the process proceeds to step S86. Specifically, when the turn of delivery of the package that is to be delivered is a value obtained by adding 1 to the turn of delivery of the package that is delivered last (referred to as the last turn of delivery), the turn-of-delivery determination unit 44 determines that the turn of delivery of the delivery address comes. When it is not determined that the turn of delivery of the delivery address comes (NO at step S90), the process proceeds to step S92.

The processing of step S92 is the same as that at step S28 and thus description thereof will be omitted.

As described above, in the fourth embodiment, the vehicle that delivers the packages enters the predetermined geofence and, based on the pre-set turn of delivery, it is determined whether to transmit notification information to the terminal device. Accordingly, in the fourth embodiment, it is possible to make a notification of notification information at more accurate timing.

### Fifth Embodiment

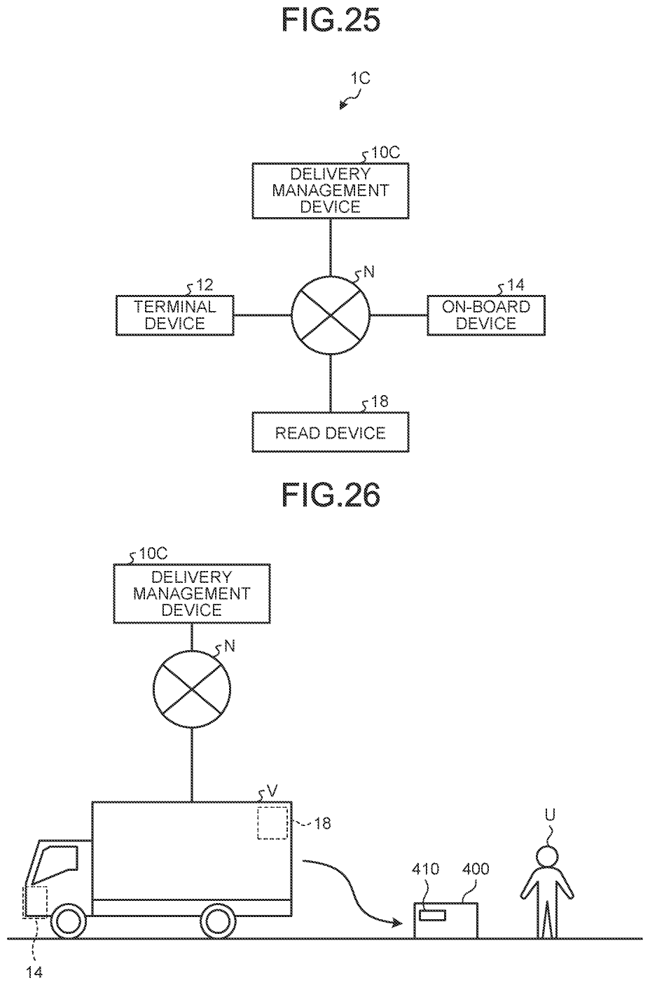

Using FIG. 25, a configuration example of a delivery management system according to a fifth embodiment will be described. FIG. 25 is a diagram illustrating the configuration example of the delivery management system according to the fifth embodiment.

As illustrated in FIG. 25, a delivery management system 1C is different from the delivery management system 1 illustrated in FIG. 1 in that the delivery management system 1C includes a delivery management device 10C and a read device 18. When a package is taken out of the vehicle, the delivery management system 1C transmits notification information to the user of the delivery address of the package.

The read device 18 is connected to the delivery management device 10C via a network N such that the devices can communicate with each another. The read device 18 is provided in a vehicle that conveys packages. FIG. 26 is a diagram for describing an overview of the fifth embodiment. As illustrated in FIG. 26, the read device 18 is arranged on a door of a vehicle V that conveys the package, or the like. The door of the vehicle V is a door that is opened and closed when packages are loaded on the vehicle or packages are taken out of the vehicle.

In the fifth embodiment, a RFID (Radio Frequency Identifier) tag 410 is attached to a package 400 that the vehicle V conveys. The RFID tag is, for example, a passive tag; however, the RFID tag may be an active tag. The read device 18 is configured to read the RFID tag 410 when the package 400 is taken out of the vehicle V by a deliverer U. For example, tag information indicating a package ID is embedded in the RFID tag 410. The package ID, that is, a delivery number and the tag information need not match and, in that case, the tag information only needs to be associated with the package information 242a. In the delivery management system 1C according to the fifth embodiment, when the read device 18 reads the RFID tag 410, the delivery management device 10C transmits notification information to the terminal device 12 of the user of the delivery address of the package 400.

Read Device

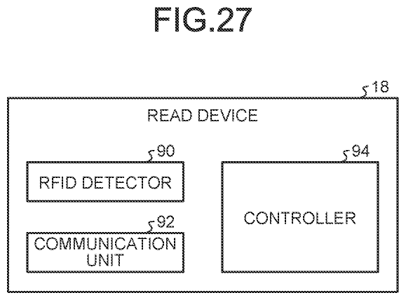

Using FIG. 27, a configuration example of the read device according to the fifth embodiment will be described. FIG. 27 is a block diagram illustrating the configuration example of the read device according to the fifth embodiment.

As illustrated in FIG. 27, the read device 18 includes an RFID detector 90, a communication unit 92, and a controller 94.

The RFID detector 90 reads an RFID tag and acquires the information that is embedded in the RFID tag. For example, as illustrated in FIG. 26, the RFID detector 90 reads the RFID tag 410 that is attached to the package 400 and acquires the tag information that is embedded in the RFID tag 410.

The communication unit 92 executes communication between the read device 18 and an external device. The communication unit 92, for example, executes communication between the read device 18 and the delivery management device 10C. The communication unit 92, for example, transmits the tag information that is acquired by the RFID detector 90 to the delivery management device 10C.

The controller 94 controls each unit of the read device 18. The controller 94, for example, includes an information processing device, such as a CPU or a MPU, and a storage device, such as a RAM or a ROM. The controller 94 executes a program for controlling operations of the on-board device 14 according to the disclosure. The controller 94, for example, may be realized using an integrated circuit, such as an ASIC or a FPGA. The controller 94 may be realized by a combination of hardware and software.

Delivery Management Device

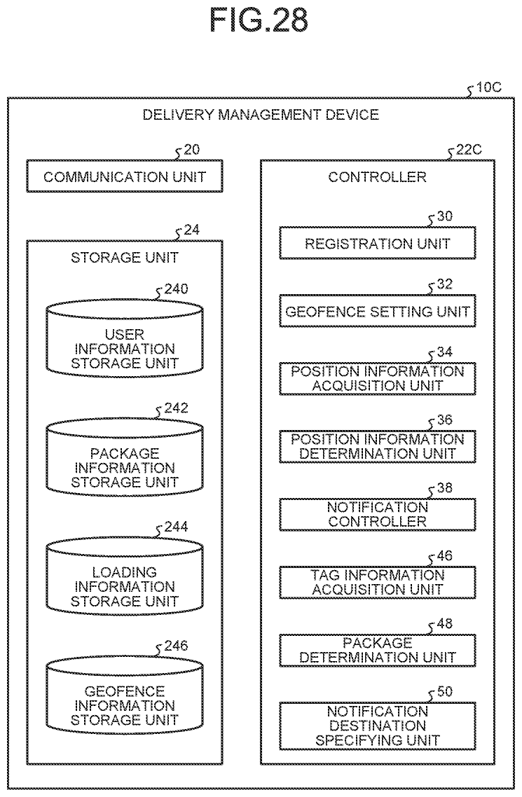

Using FIG. 28, a configuration example of the delivery management device according to the fifth embodiment will be described. FIG. 28 is a block diagram illustrating the configuration example of the delivery management device according to the fifth embodiment.

As illustrated in FIG. 28, the delivery management device 10C is different from the delivery management device 10 illustrated in FIG. 2 in that a controller 22C includes a tag information acquisition unit 46, a package determination unit 48, and a notification destination specifying unit 50.

The tag information acquisition unit 46 acquires a result of detection of an RFID tag that is performed by the RFID detector 90 from the read device 18 via the communication unit 20.

The package determination unit 48 determines whether the package has been taken out of the vehicle. When the tag information acquisition unit 46 acquires the tag information, the package determination unit 48 determines that the package to which the RFID tag with the tag information embedded therein is attached has been taken out of the vehicle.

Based on the user information 240a that is stored in the user information storage unit 240, the notification destination specifying unit 50 specifies a notification destination corresponding to the user that is associated with the tag information that is acquired by the tag information acquisition unit 46.

Notification Information Transmitting Process

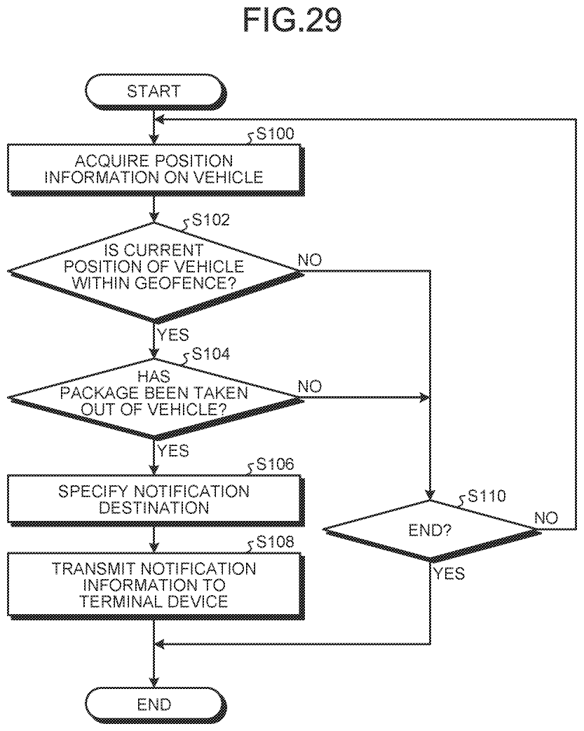

Using FIG. 29, a process of transmitting notification information according to the fifth embodiment will be described. FIG. 29 is a flowchart illustrating the process of transmitting notification information according to the fifth embodiment.

The sets of processing of steps 5100 and 5102 are the same as those of steps S20 and S22 illustrated in FIG. 11, respectively, and thus description thereof will be omitted.

When an YES determination is made at step 5102, the package determination unit 48 determines whether the package has been taken out of the vehicle (step S104). Specifically, when the tag information acquisition unit 46 acquires the tag information from the read device 18, the package determination unit 48 determines that the package has been taken out of the vehicle. When it is determined that the package has been taken out of the vehicle (YES at step S104), the process proceeds to step 5106. When it is not determined that the package has been taken out of the vehicle (NO at step S104), the process proceeds to step S110.

When an YES determination is made at step S104, the notification destination specifying unit 50 specifies a notification destination of notification information (step S106). Specifically, the notification destination specifying unit 50 specifies a package ID based on the tag information, specifies a user of a delivery address of the package ID based on the package information 242a that is stored in the package information storage unit 242, and specifies a notification destination corresponding to the user of the delivery address based on the user information 240a that is stored in the user information storage unit 240. The process then proceeds to step S108.

The sets of processing of steps S108 and S110 are the same as those of steps S26 and S28 illustrated in FIG. 11, respectively, and thus description thereof will be omitted.

As described above, in the fifth embodiment, when the vehicle that delivers the package enters the predetermined geofence and the package is taken out of the vehicle, the user is notified of the notification information. Thus, in the fifth embodiment, it is possible to transmit the notification information to the notification destination at more accurate timing.

### Sixth Embodiment

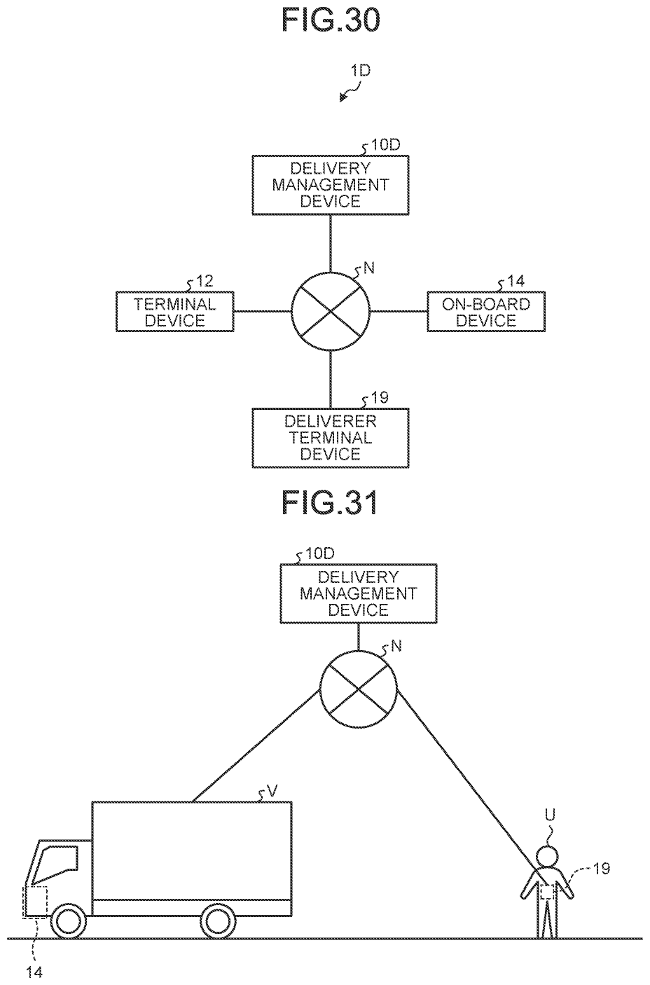

Using FIG. 30, a configuration example of a delivery management system according to a sixth embodiment will be described. FIG. 30 is a diagram illustrating the configuration example of the delivery management system according to the sixth embodiment.

As illustrated in FIG. 30, a delivery management system 1D is different from the delivery management system 1C illustrated in FIG. 25 in that the delivery management system 1D does not include the read device 18 and includes a delivery management device 10D and a deliverer terminal device 19. The delivery management system 1D is a system that transmits notification information to a user of a delivery address of a package based on a positional relationship between a vehicle that conveys the package and a deliverer who has taken the package out of the vehicle.

The deliverer terminal device 19 is connected to the delivery management device 10D via a network N such that the devices can communicate with each another. The deliverer terminal device 19 is held by the deliverer of the package. The deliverer terminal device 19 acquires information of a current position. The deliverer terminal device 19 is, for example, an information terminal device, such as a smartphone or a table terminal device.

FIG. 31 is a diagram for describing an overview of the sixth embodiment. In the sixth embodiment, after it is determined whether a vehicle V is positioned within a predetermined geofence, the delivery management device 10D acquires position information on the vehicle V from the on-board device 14 via the network N and acquires position information on a deliverer U from the deliverer terminal device 19. The delivery management device 10D determines the positional relationship between the vehicle V and the deliverer U. When it is determined that the deliverer U is moving in a direction such that the positions of the vehicle V and the deliverer U are away from each other, the delivery management device 10D transmits the notification information to the terminal device 12 of the user of the delivery address of the package.

Deliverer Terminal Device

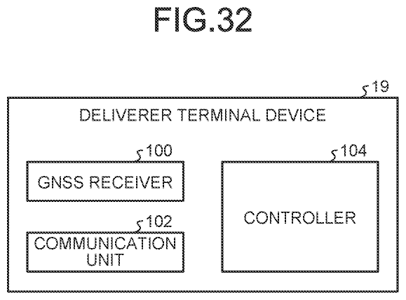

Using FIG. 32, a configuration example of the deliverer terminal device according to the sixth embodiment will be described. FIG. 32 is a block diagram illustrating a configuration example of a deliverer terminal device according to the sixth embodiment.

As illustrated in FIG. 32, the deliverer terminal device 19 includes a GNSS receiver 100, a communication unit 102, and a controller 104.

The GNSS receiver 100 receives a GNSS signal containing information for specifying position information from GNSS satellites (not illustrated in the drawing). The GNSS receiver 100, for example, can be realized using a GNSS receiving circuit or a GNSS receiving device. The GNSS receiver 100 may receive information for specifying the position information from one other than GNSS satellites.

The communication unit 102 executes communication between the deliverer terminal device 19 and an external device. The communication unit 102, for example, executes communication between the deliverer terminal device 19 and the delivery management device 10D.

The controller 104 controls each unit of the deliverer terminal device 19. The controller 104, for example, includes an information processing device, such as a CPU or a MPU, and a storage device, such as a RAM or a ROM. The controller 104 executes a program for controlling operations of the deliverer terminal device 19 according to the disclosure. The controller 104, for example, may be realized using an integrated circuit, such as an ASIC or a FPGA. The controller 104 may be realized by a combination of hardware and software.

Delivery Management Device

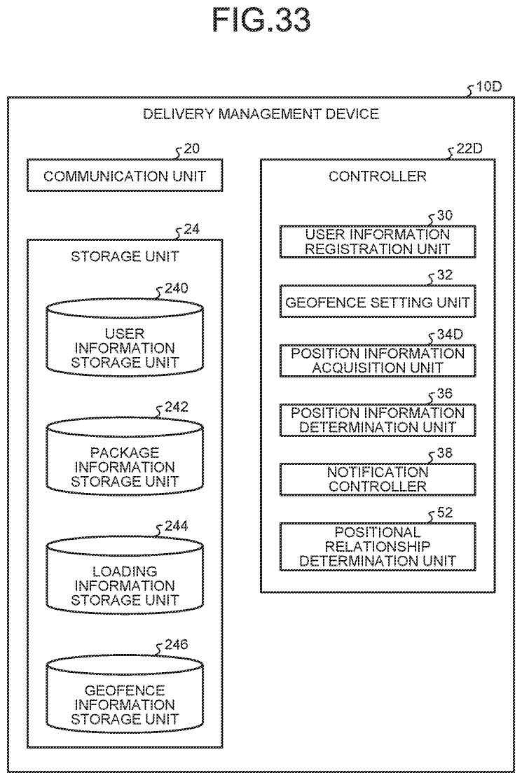

Using FIG. 33, a configuration example of the delivery management device according to the sixth embodiment will be described. FIG. 33 is a block diagram illustrating the configuration example of the delivery management device according to the sixth embodiment.

As illustrated in FIG. 33, the delivery management device 10D is different from the delivery management device 10 illustrated in FIG. 2 in that a controller 22D includes a position information acquisition unit 34D and a positional relationship determination unit 52.

The position information acquisition unit 34D acquires information of a current position of the vehicle from the on-board device 14 via the network N. The position information acquisition unit 34D acquires information of a current position of the deliverer from the deliverer terminal device 19 via the network N.

After the package is taken out of the vehicle that conveys the package, the positional relationship determination unit 52 determines a positional relationship between the vehicle and the deliverer. The positional relationship determination unit 52 determines the positional relationship between the vehicle and the deliverer based on the information of the current position of the vehicle and the information of the current position of the deliverer that are acquired by the position information acquisition unit 34D.

Notification Information Transmitting Process

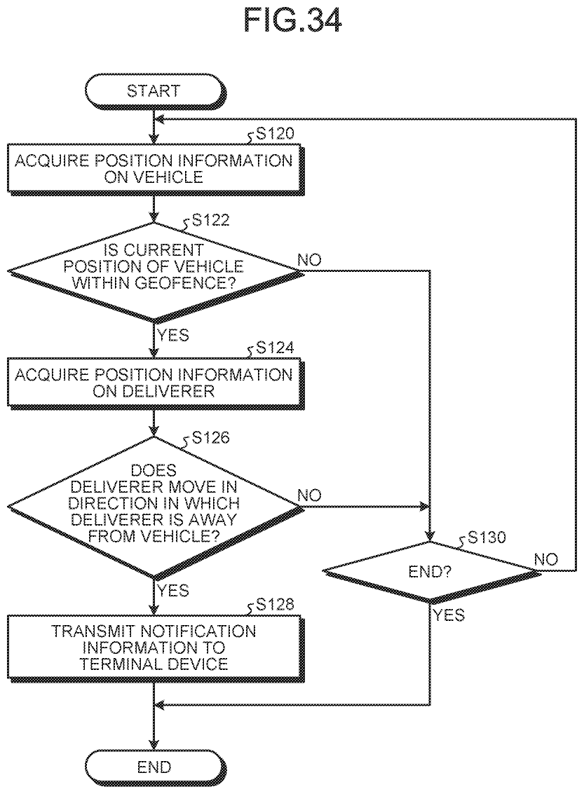

Using FIG. 34, a process of transmitting notification information according to the sixth embodiment will be described. FIG. 34 is a flowchart illustrating the process of transmitting notification information according to the sixth embodiment.

The sets of processing from step S120 and S122 are the same as those of steps S20 and S22 illustrated in FIG. 11, respectively, and thus description thereof will be omitted.

After step S122, the position information acquisition unit 34D acquires position information on the deliverer from the deliverer terminal device 19 via the network N (step S124). The process then proceeds to step S126.

The positional relationship determination unit 52 determines whether the deliverer is moving in a direction in which the deliverer is away from the vehicle (step S126). Specifically, when the deliverer is moving in a direction in which the position information on the deliverer is away from the vehicle based on the position information on the vehicle and the position information on the deliverer each of which is acquired for multiple times at different times, the positional relationship determination unit 52 determines that the deliverer is moving in a direction in which the deliverer is away from the vehicle. For example, when the distance between the position information on the vehicle and the position information on the deliverer at a certain time is smaller than a distance between the position information on the vehicle and the position information on the deliverer at a time after the certain time, the positional relationship determination unit 52 determines that the deliverer is moving in a direction in which the deliver is away from the vehicle. When it is determined that the deliverer is moving in a direction in which the deliver is away from the vehicle (YES at step S126), the process proceeds to step S128. When it is not determined that the deliverer is moving in a direction in which the deliver is away from the vehicle (NO at step S126), the process proceeds to step S130.

The sets of processing of steps 5128 and 5130 are the same as those of steps S26 and S28 illustrated in FIG. 11, respectively, and thus description thereof will be omitted.

As described above, in the sixth embodiment, when the vehicle that delivers the package enters the predetermined geofence and the deliverer moves in a direction in which the deliverer is away from the vehicle, the user is notified of the notification information. Thus, in the sixth embodiment, it is possible to transmit the notification information to the notification destination at better timing.

The disclosure includes items that contribute to realization of “Industry, Innovation and Infrastructure” of SDGs and contribute to creation of values by IoT solutions.

According to the disclosure, it is possible to be ready for receiving a package before the package is delivered.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery management device that manages a package to be delivered to a delivery address, the delivery management device comprising:
a geofence setting unit that sets a geofence for each delivery address to which the package is delivered;
a position information acquisition unit that acquires position information on a vehicle that delivers the package;
a position information determination unit that determines whether a current position of the vehicle that delivers the package to the delivery address is positioned within the geofence corresponding to the delivery address; and
a notification controller that transmits notification information to a terminal device in the delivery address of the package when it is determined that the current position of the vehicle is positioned within the geofence.

2. The delivery management device according to claim 1, wherein the position information determination unit determines whether the current position of the vehicle is on a side road, and
the notification controller transmits the notification information to the terminal device when it is determined that the current position of the vehicle is within the geofence and is on the side road.

3. The delivery management device according to claim 1, wherein the position information determination unit determines whether an entrance of the delivery address faces a main road, and
the notification controller changes the notification information according to a position of the entrance of the delivery address.

4. The delivery management device according to claim 1, further comprising a positional relationship determination unit that determines a positional relationship between the vehicle and a deliverer that delivers the package,
wherein the position information acquisition unit further acquires position information on a deliverer terminal device that the deliverer holds,
based on the position information on the vehicle and position information on the deliverer, the positional relationship determination unit determines whether the deliverer is moving in a direction in which the deliverer is away from the vehicle, and
the notification controller transmits the notification information to the terminal device when it is determined that the deliverer is moving in a direction in which the deliverer is away from the vehicle.

5. A delivery management method comprising:
setting a geofence for each delivery address to which the package is delivered;
acquiring position information on a vehicle that delivers the package;
determining whether a current position of the vehicle that delivers the package to the delivery address is positioned within the geofence corresponding to the delivery address; and
transmitting notification information to a terminal device in the delivery address of the package when it is determined that the current position of the vehicle is positioned within the geofence.
